(19) United States
(12) Patent Application Publication
(10) Pub. No.: US 2009/0193227 A1
(43) Pub. Date: Jul. 30, 2009

(54) Multi-stream on-chip memory

(76) Inventor: Martin John Dowd, Costa Mesa, CA (US)

Correspondence Address: Martin Dowd, 1613A Wintergreen Pl., Costa Mesa, CA, 92626, US

(21) Appl. No.: 12/011,182

(22) Filed: Jan. 25, 2008

(51) Int. Cl. G06F 15/76; G06F 9/02

(52) U.S. Cl. 712/29; 712/E09.002

(57) ABSTRACT

An interface to on-chip memory is described, which provides for using on-chip memory by a RISC superscalar processor, enhanced with methods which execute vector operations by treating the vectors as “streams”, which are fed through one or two function units in a pipelined manner. The interface provides concurrent multiple streams, while at the same time serving “conventional” requests from the host RISC superscalar processor.

### BACKGROUND OF THE INVENTION

Field: Computer logic design.

The applicant has been proposing a new type of computer architecture, which incorporates vector processing into a RISC superscalar microprocessor chip. The applicant has prepared for publication a manuscript (“RISC Vector Multiprocessors”) giving a description of a uniprocessor, and an on-chip multiprocessor comprised of said uniprocessors.

The uniprocessor provides vector processing using special registers to provide in the machine language the ability to access on-chip memory, for reading or writing, in such a way that data can be fed to the input stage of a function unit, and simultaneously written from the output stage, at the rate of one item per cycle. The item size might have various values, with 64 bits being a size of typical interest.

These special registers can be viewed as providing the use of “data streams” to the instruction sequence being executed by the processor. Any number might be provided; a value of 4 is considered in the manuscript. To achieve 4 simultaneous streams, an interface between the processor and the on-chip memory must be provided. Further, the interface must handle “conventional” requests from a RISC superscalar processor, which hosts the vector methods which use the streaming capability. Such an interface is described herein.

The number of streams above is the number available in a single processor. An on-chip multiprocessor might have 32 processors with 64 Kilobytes of on-chip memory each, resulting in 128 streams available in the multiprocessor, to a total of 2 Megabytes of memory; with a 2.5 GHz processor clock the resulting memory bandwidth is 2.5 Terabytes per second.

The method of vector processing provided by a processor based on the memory interface described herein differs from vector microprocessor architectures which have previously considered, such as those of “Vector Microprocessors”, Ph. D. thesis, University of California, Berkeley, 1998, by K. Asanovic; or the “SX-4 Series CPU Functional Description Manual”, NEC Corporation, 1997 (available online). The major difference is that there are no vector registers; rather vectors are loaded into on-chip memory, and accessed using streaming.

A processor based on a streaming interface to on-chip memory is of interest. It adopts a “minimalist” approach, relying on the interface to provide memory bandwidth which can keep one or two pipelined function units saturated. This provides vector processing in an efficient, robust superscalar processor with very low additional cost.

The method described herein might be considered an evolutionary successor to methods which were used in earlier memory-to-memory vector computers. The CDC Cyber 205 is one example. According to

http://homepages.inf.ed.ac.uk/rni/comp-arch/uni/Vect/cyber-vec.html, the Cyber 205 has “stream units”. These communicate with “memory banks” and check for “bank busy”.

The design described herein provides streams in a more integrated manner, so that they may be used to provide vector processing using on-chip memory in a RISC micro-processor. The request data width is modest, say 64 bits, and vector processing is more integrated with conventional processing.

Streams previously considered in the literature are to off-chip memory. For example, U.S. Pat. No. 7,159,099, “Streaming vector processor with reconfigurable interconnection switch”, describes using such streams as input and output for a configurable vector processor. There is a body of other literature on “configurable computers”. By contrast, the design described herein is an integrated interface providing stream access to on-chip memory, for vector operations by an ordinary (non-configurable) processor. Configurability is omitted in favor of using the memory interface described herein, to execute sequences of operations on vectors, storing and re-using intermediate vectors. This provides comparable performance, without the need for additional hardware for configuration, which in turn permits a higher density of individual processors in a multi-processor.

Streams are also present in Graphical Processing Units (GPU's). A generic description of GPU-type processors can be found in “Memory Hierarchy Design for Stream Computing” by Nuwan Jayasena, available at

cva.stanford.edu/publications/2005/jayasena_thesis.pdf, GPU's are coprocessors in a heterogeneous assembly, with the streams data residing in DRAM. Memory sectioning may be used to increase stream bandwidth; see “Graphics Processing Unit Architecture (GPU Arch) With a focus on NVIDIA GeForce 6800 GPU” by Ajit Datar and Apurva Padhye, available at

www.d.umn.edu/data0003/Talks/gpuarch.pdf.

“Merrimac: Supercomputing with Streams” by W. Dally et al, available at

www.sc-conference.org/sc2003/paperpdfs/pap246.pdf, suggests that a large multicomputer be built using streaming “nodes” rated at over 100 GFlops. The nodes considered in this reference have a specialized architecture and use different methods than those considered herein. The methods considered herein are general purpose, and nodes of the suggested performance can be achieved using them. For example, a node consisting of 32 RISC vector processors, operating at 2.5 GHz, has a peak rating of 160 GFlops.

Providing streams in the main processor yields improvement in uniprocessor performance, with low additional transistor count. In addition, specialized “enhanced” processors can be manufactured by adding features to a basic processor, providing an alternative approach to processor design in areas such as graphics processing, digital signal processing, and specific numerical applications such as partial differential equations.

### BRIEF SUMMARY OF THE INVENTION

Multiple data streams may be provided as an enhancement to on-chip memory, for use in a new type of RISC superscalar processor. Memory is sectioned into n “banks” (n=4 being a value of interest). It is also sectioned into m “rows” (m=4 being a value of interest). The partitions are orthogonal, so memory is divided into an n by m array of modules.

The row number of a request is determined by the low order bits (2 bits in the case m=4) of the memory cell address (64 bits being a memory cell width of interest). There is one stream per bank. Each stream has a port, which may operate in streaming mode. The bank number is unknown for an ordinary request, and the port number for a streaming request.

A system of registers and logic networks is described, which advance the command through the ports, modules, and writeback logic; and handle non-existent address exceptions. An important property of the system is its support for the use of virtual addresses.

### DETAILED DESCRIPTION OF THE INVENTION

In order to provide a context for describing the memory interface, a specific system using it will be described. Specific values are given for various parameters; but these are for the example and may be varied.

The processor communicates with memory by issuing commands to “ports”. In cycle 1 (dispatch) of a processor instruction, these commands are added to the port command queue. In cycle 2 the function unit (FU) performs a guaranteed read to the port. The port has a wrap-around array of “slots”. The port returns the slot index, or in some cases the data (if it is already in the port, due to read-ahead or accessing a subunit of a doubleword). Six lines from the function units through the pointer registers are required to obtain the slot indexes; and an additional 4 lines through the data values.

The port enters the address into the command in cycle 2, and for a read, dispatch to the module may occur (see below). A module writes the data for the read to the slot. A function unit reads its slot(s) as needed, for the command at the head of its queue, until all data is obtained. The FU's have some number (for example 3) of dynamically allocated read lines through the data values of the pointer registers. For a write, a memory port waits until the data appears in the command at the head of the queue. For pointer register ports, this will occur in writeback from the function unit.

Four of the pointer registers may be used for concurrent pipelined streams. The internal memory (IM) interface specified here supports transfer of one doubleword per cycle in each stream, permitting an external memory transfer to take place simultaneously with a 3 operand pipelined vector operation. The interface also provides for concurrent multiple operations in general computation.

Internal memory is divided in to 4 banks and 4 rows, giving 16 modules. A module has ¼ of each page. Each ¼ page has its virtual page number stored in it. The memory addressing lines perform an associative comparison on these bits. Modules execute doubleword transfers in parallel. The row number is determined by bits 1-2 of the word address. The bank number is determined by where the virtual page is located. In some cases it may be required that this is in a particular bank; in others it might be in any bank.

The example here will consider 10 ports, as follows.

0-7: pointer registers (0-3 may be operated as streams)

8: secondary instructions (e.g., load/store)

9: instruction fetch/loop load

As already mentioned, a port has a slot array for requests, with the length depending on the port. This is operated in a manner dependent on the port. New requests are added when other components make requests. In ports 0-7, not every slot requires a module command, because some requests to the port concern portions of a doubleword which was involved in the previous request. A linked list through the slots is maintained, of the slots requiring a module command. In ports 8 and 9, a command is issued for every slot.

Module commands may complete out of order. Writeback from a module is to the slot originating the command. For reads to ports 0-7, the FU proceeds when the slot indicates that the read is complete. Port 8 is used similarly; port 9 serialize the writeback.

A command has a variety of flag bits, in particular the following.
Active. This is set when a slot is allocated, and reset when activity on the slot has ceased.
New. This is set when a slot is allocated, and reset in the next cycle.
Data present. This is set for read operations by the module writeback, and for write operations by a function unit.
For 0≦i≦4, bank i will receive a command.
For 0≦i≦4, waiting for bank i to reply.
Succeeded (some bank completed request).
0 if R (read), 1 if W (write).
1 if pointer value operation (ports 0-7).
Read pending (ports 0-8). A function unit will read the slot. Set when the slot is allocated, and reset by the function unit.

The “command needed” flags are set in the cycle following that when the slot is allocated. Either 1 (pipelined), or 4, bits are set. These bits are reset in the cycle when the module serves the port, which may be the next one. If these bits are reset, or being reset, the head command of the port is advanced.

Fairness is ensured as follows. Let rₚₘ be 1 if the head request of port p is requesting module m; this is determined by applying a logic circuit to 4 bank request bits in the command, and the row number. Fixing m, let q be the last port served by module m; let r′ₚₘ be the bits obtained by shifting circularly the bits rₚₘ by the amount q; and let sₜₘ be 1 if t is the least p for which r′ₚₘ=1, else 0. Module m uses the bits sₚₘ to read a command from the ports. Port p uses them to determine whether the bank request bit in the head command should be reset.

For an active slot to be finished, the “waiting for module reply” flags must all be reset. A trap occurs if the “succeeded” flag is reset. For an R slot for ports 0-8, the “read pending” flag must also be reset for the slot to be finished. Even though the output of the reset circuit includes the input, the active flag can probably be reset in the cycle during which the other inputs become reset.

A module takes two cycles to complete an operation. For a read, cycle 1 reads the data, and cycle 2 stores it in the slot and updates the slot state. For a write, cycle 1 stores the data, and cycle 2 updates the slot state. The second cycle can overlap the first cycle of the next command, at least for a “plain” write.

The modules must support “masked” writes, with an 8 bit mask specifying the bytes to be written. A masked write precludes overlap of the next command in cycle 2 (so the module will not serve any ports). In the initial simulator, if the mask is either the left or right subword, the write is not considered masked. This requires 32 data lines, and 256 address lines per page. If word writes disallow overlap then 64 data lines, and 128 address lines per page are required.

Ports 0-3 support read-ahead and delayed write (for size less than doubleword), if pipelined and the length is set. Serialization terminates read-ahead, and issues commands for delayed writes. Software should attempt to avoid use of pipelined pointer registers, with cell size less than doubleword.

Each port slot has a collision detector, which detects collisions for new slots. In cycle t, if there is a new write which collides with another new slot, a trap occurs. If there is a collision with a write which is not new, such reads get flagged as “delayed”, and serialization is initiated for cycle t+1. Delayed slots wait until only delayed slots remain.

1. A method for providing on-chip microprocessor memory with facilities permitting access via multiple pipelined streams, as a feature additional to conventional memory use by the processor. The method is based on the use of ports, one per stream, which when operating in streaming mode access only a section (“bank”) of memory, the ports which may operate in this manner being in one-to-one correspondence with the banks. Conventional memory commands are sent to all banks. The memory is divided into n times m modules, where n is the number of banks, and m is the interleaving factor, a power of 2. A request from a streaming port is sent to one module, determined by the port, and low order bits of its address. A conventional request is sent to n modules, based on the low order bits of the address. A system of registers and logic networks is used to implement the progress of a command through the ports, modules, and writeback logic; and to handle non-existent address exceptions.
